(19) United States
(12) Patent Application Publication
(10) Pub. No.: US 2021/0309505 A1
(43) Pub. Date: Oct. 7, 2021

(54) Fluid Transfer Device

(71) Applicant: Craig Tetley, Benton, MT (US)

(72) Inventors: Craig Tetley, Benton, MO (US); Jason McGrath, Boulder, CO (US); Shane Vogt, Boulder, CO (US)

(21) Appl. No.: 16/842,667

(22) Filed: Apr. 7, 2020

(51) Int. Cl. B67D 7/02; B67D 7/84; B67D 7/30; B67D 7/58

(52) U.S. Cl. CPC B67D 7/0205; B67D 7/845; B67D 2210/00152; B67D 7/30; B67D 7/58; B67D 7/0277

(57) ABSTRACT

A fluid transfer device is implemented which has an inlet for receiving a fluid from a subject container or reservoir and an easily controllable outlet to direct the received fluid to a desired location, such as a target container or reservoir. The inlet and outlet may both include conical spouts to which various sized hoses can removably attach to enable directional and maneuverable control for a user. The fluid transfer device includes a base which rests on a surface and provides support for the components above it, including a handle and an operational arm that handles the fluid transfer operations. The fluid transfer device is configured with versatility for adaptability to multiple use cases. For example, the fluid transfer device has a height-adjustable handle to accommodate differently sized containers, a hinged operational arm, and a horizontally-adjustable container rest.

### BACKGROUND

The average person and skilled artisans, like mechanics and plumbers, may want to move fluids from one container to another. This seemingly easy task can be difficult and messy without having the appropriate tools and/or placing down protective mats to prevent staining from spillage. A mechanic may have difficulty transferring liquids from a bottle, oil jug, or water container to an obscured inlet—such as an inlet positioned over his or her head, blocked by pieces of metal underneath a vehicle, or adjacent to dangerously high-temperature areas which can cause the mechanic physical harm. Thus, transferring fluid from one location to another can be difficult, time-consuming, and, at times, dangerous.

### SUMMARY

A fluid transfer device is implemented which has an inlet for suctioning a fluid from a subject container or reservoir and an easily controllable outlet to direct the suctioned fluid to a desired location, such as a target container or reservoir. The inlet and outlet may both include conical spouts to which various sized hoses can removably attach to enable directional and maneuverable control for a user, such as an artisan like a mechanic or plumber, or homeowner.

The fluid transfer device includes a base configured to rest on a surface, such as a tabletop, counter, or the ground, and support the upper components of the device. A container rest extends horizontally from the base and on which a subject container can be placed. A handle extends vertically upward from the base and is vertically adjustable to provide varying length to accommodate differently sized containers. An operational arm extends horizontally from the handle and, in typical implementations, is aligned with the container rest that extends from the base. The operational arm includes a downward facing inlet positioned on an underside of the operational arm and an upward facing outlet positioned on an upper surface of the operational arm. While the terms “inlet” and “outlet” are used herein, as discussed in greater detail below, the flow path of the fluid transfer device is bi-directional such that, depending on the set flow path, the inlet and outlet can reverse functions.

A hinge is positioned adjacent to the handle and about which the operational arm pivots upward to enable, if necessary, larger sized containers to be placed underneath the arm. The operational arm may include a buckle mount to which a nylon strap can attach for holding a container in place. The strap can extend from the buckle mount and extend underneath the container rest. The strap can be adjustable using the buckle mount to accommodate varying girths from differently sized containers.

The fluid transfer device can include a computing module for controlling automated and manual operations. The computing module includes a display screen that can be utilized as an output mechanism to present information to the user. In some implementations, the display screen can be a touchscreen display to additionally support user inputs. Other input mechanisms can also be utilized, such as mechanical buttons and a click/roll wheel which provides scrolling and a button function. The computing module's input/output (I/O) devices can enable the user to make various selections for operations, such as a directional flow path of fluid, units of measure for the fluid transfer, and a fluid transfer capacity which can include an amount of fluid to transfer and a rate at which the fluid is transferred. The fluid transfer device may operate once the device is switched on and then the user presses an actuator button. The fluid transfer device may operate according to a default setting for the automated and manual selections or according to some pre-set user setting.

The fluid transfer device resolves the difficulties in transferring fluid between reservoirs by facilitating a versatile and convenient user experience via its ergonomic design. For example, the fluid transfer device can hold a subject container in place, provides manual and automated operations, and enables directional inlet and outlet control using the removable hoses, among other features. The versatility of the fluid transfer device is immeasurable—plumbers can use the device to drain pipes, mechanics can use the device to empty oil pans or empty or fill a vehicle's reservoir, and homeowners, artisans, and handymen can use the device in transferring water to or from an aquarium, lawnmower, or any other tank. In short, the disclosed device is a catch-all fluid transfer device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative layered architecture of a fluid transfer device;

FIG. 2 shows an illustrative and non-exhaustive manifest of internal operational components of the fluid transfer device;

FIG. 3 shows an illustrative representation of the fluid transfer device;

FIG. 4 shows an illustrative representation of a computing module's input/output devices on the fluid transfer device;

FIG. 5 shows an illustrative representation of the versatility of the fluid transfer device to accommodate differently sized containers;

FIG. 6 shows an illustrative representation in which a container is secured in place by a strap for a fluid transfer operation;

FIG. 7 shows an illustrative representation in which the fluid transfer device suctions fluid from a subject container to a target container;

FIG. 8 shows an illustrative representation of exemplary operations controllable by a user using the input/output devices; and

FIG. 9 shows an illustrative block diagram of the fluid transfer device's system architecture.

Like reference numerals indicate like elements in the drawings. Elements are not drawn to scale unless otherwise indicated.

### DETAILED DESCRIPTION

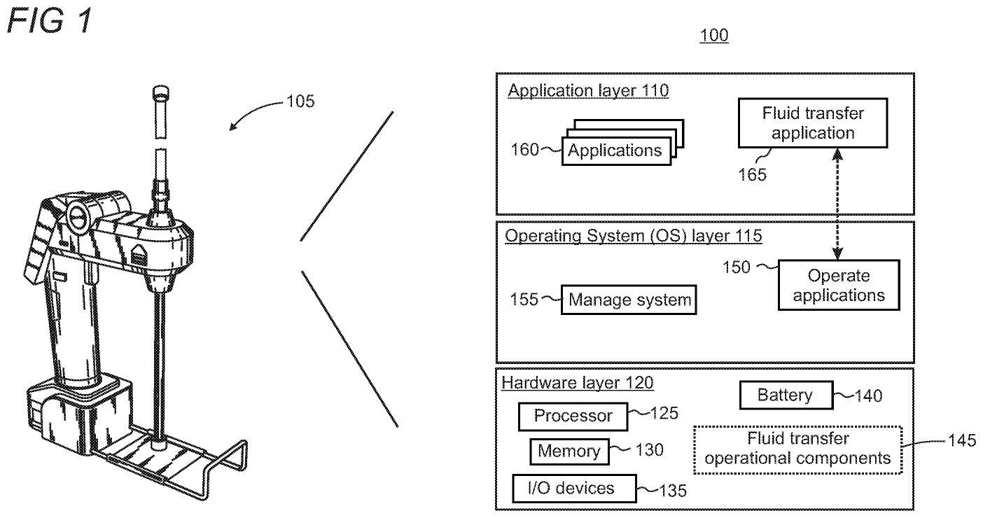

FIG. 1 shows an illustrative system architecture 100 for the fluid transfer device 105, which includes various components typically associated with a computing device to facilitate some of the device's operational functions. The exemplary and simplified architecture is arranged in layers and includes a hardware layer 120, an operating system (OS) layer 115, and an application layer 110. The hardware layer 120 provides an abstraction of the various hardware used by the fluid transfer device 105 to the layers above it. In this illustrative example, the hardware layer supports one or more processors 125, memory 130, input/output (I/O) devices 135, a battery 140, such as a rechargeable lithium battery, and fluid transfer operational components 145. Although not shown in the drawings, a printed circuit board (PCB), such as a flexible PCB may be utilized for the memory and processor components.

In typical implementations, the one or more processors 125 may be a central processing unit (CPU) or a microcontroller configured to perform discrete operations. The memory 130 may include data and instructions which are executable by the one or more processors. The I/O devices, as described in greater detail below, can include various devices including a touchscreen display, push-buttons, such as for actuation or switching the device on and off, a roll/click wheel, among other I/O devices.

The OS layer 115 supports, among other operations, managing the operating system 155 and operating applications 150, as illustratively shown by the arrow. The OS layer may interoperate with the application and hardware layers to facilitate execution of programs and perform various functions and features.

The application layer 110 can support various applications 160, including a fluid transfer application 165. The fluid transfer application may be configured to support various fluid transfer operations, including automated and manual fluid transfer operations. The specific operations of the fluid transfer application may depend on, for example, the user's input selection at the I/O device.

The fluid transfer application may be configured to operate at a default setting for the automated and manual options or according to some user selection. For example, for the manual and automated options, a default setting may cause the device to transfer fluid at some pre-set rate responsive to user pressing an actuator button. In other implementations, the device may transfer a set amount of fluid according to some user-selected setting, like one gallon. The automated setting may work with a single press of the actuator trigger, whereas the manual setting may work while the user maintains pressure on the trigger. Any number of applications can be utilized by the fluid transfer device 105, whether proprietary or third-party applications. In typical implementations, the applications may be implemented using locally executing code stored in memory 130.

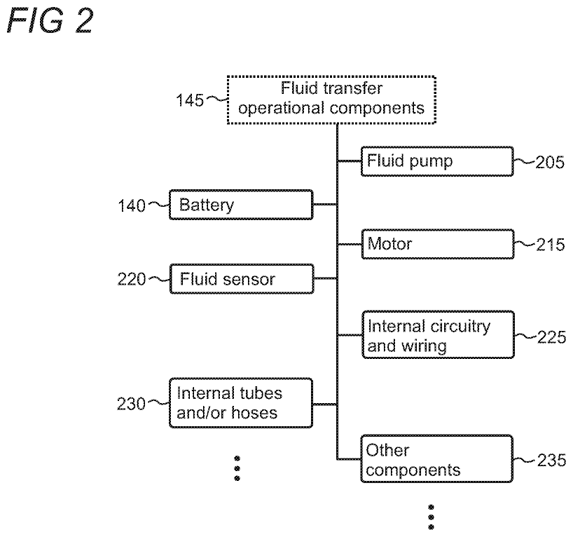

FIG. 2 shows an illustrative and non-exhaustive manifest of the fluid transfer device's components which are utilized to facilitate the fluid transfer operations, as representatively shown by numeral 145. In typical implementations, the fluid transfer components can include a fluid pump 205, battery 140, motor 215, fluid sensor 220, internal circuitry and wiring 225, internal tubes and hoses 230, and other components 235 depending on the implementation.

The motor 215 provides is an electromechanical source which transforms electrical energy from the battery or other power source into mechanical torque. The motor enables the pump 205 to convert the mechanical torque from the motor into hydraulic/pressure energy to enable fluid transfer. The pump may be configured to create a vacuum to suction water from an inlet and push the pump out an outlet. Exemplary types of fluid pumps include a positive displacement pump, rotary positive displacement pump, piston pumps, among other pumps. The pump may be configured for bi-directional flow so that the inlet and outlet can switch functions. The internal circuitry and wiring 225 can be utilized to connect the various components together, such as the battery 140 and processor 125 to the fluid transfer components 145. The internal tubes and/or hoses 230 are utilized to receive the fluid from the inlet and provides the flow path for the fluid to the outlet.

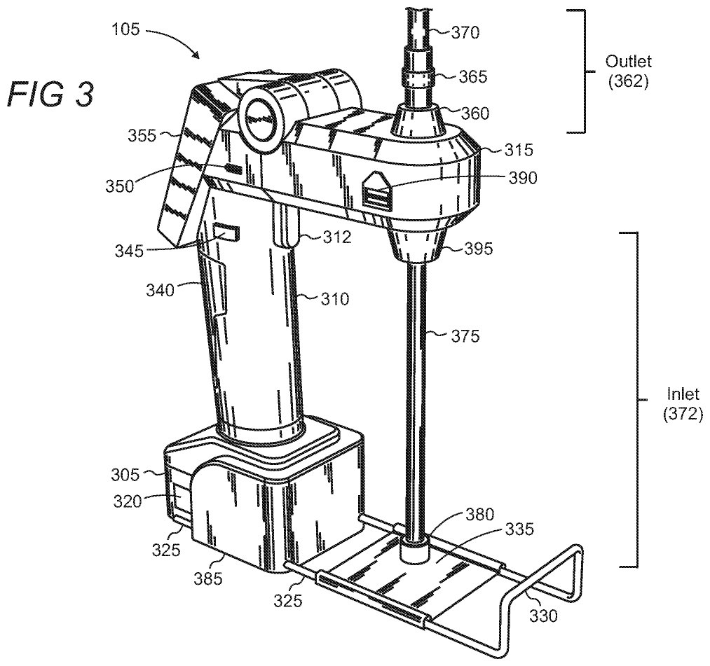

FIG. 3 shows an illustrative representation in which the fluid transfer device 105 is broken down into various parts. Simplistically, the fluid transfer device includes a base 305 which provides support to the components above it, a handle 310, and an operational arm 315 which facilitates the various fluid transfer operations.

The base 305 includes an adapter 385 from which a container rest 325 extends horizontally. Subject containers that a user intends to transfer fluid from can be placed on the container rest, such as on the container rest's platform 335. In this implementation, the container rest includes two wire elements comprised of metal or plastic, each of which extends into the adapter 385. The wire elements includes a stopper 330 which helps secure the container (not shown) between the stopper and base.

The handle 310 extends vertically upward from the base 305 and is ergonomically shaped to enhance user comfort and handling. The handle includes a grip 340 which may be a rubber material to further improve user handling. As discussed in greater detail below, the handle is a telescoping handle that can increase the height of the fluid transfer device 105 to accommodate larger sized containers. A button actuator 312 is in a trigger position to enable a user to switch the fluid transfer operations on and off after the device is switched on using the computer module 355. The lock switch 350 is adapted to unlock the adjustable handle from various locking positions. The handle includes a computing module 355 that faces away from the operational arm 315 for easier viewing. Hinge lock switch 345 is implemented to unlock the hinge mechanism for the operational arm 315 from a locked position, as discussed in greater detail below.

The operational arm 315 extends in a horizontal direction, such as perpendicular, from the handle 310 and includes the inlet and outlet components which facilitate fluid transfer. In typical implementations, the operational arm extends such that it is aligned with the container rest 325 so containers can be positioned in between the two. The operational arm includes a buckle mount 390 on opposing sides of the arm which can be used with a nylon strap (not shown) to wrap around and secure a container in place.

An inlet 372 includes various components in which fluid is suctioned and received into the fluid transfer device 105, including a rubberized conical spout 395, inlet hose 375, and a screen-filtered inlet fitting 380. The conical spout is adapted to enable hoses of various lengths to be removably attachable thereto. For example, the conical spout can be a press-fit attachment mechanism or threaded depending on the implementation.

An outlet 362 includes various components through which fluid exits the fluid transfer device 105, including a rubberized conical spout 360, quick-release collar 365 (e.g., quick-connect or push-to-connect coupler), and outlet hose 370. The quick-release collar may be adapted to receive hoses of varying lengths and enable quick release and attaching of the outlet hoses to enhance the adaptability and versatility of the fluid transfer device for handling an array of use cases.

While inlet 372 and outlet 362 are depicted and described herein to describe an exemplary flow path, the fluid transfer device is configured for bi-directional fluid transfer. Therefore, in other implementations, the functions of the inlet and outlet may switch. Furthermore, the inlet and outlet is not restricted to any particular composition of components, and can include the conical spouts with or without the respective hoses. The meaning of inlet and outlet as used herein refer to the location at which fluid enters and exits the fluid transfer device, whether or not hoses or conical spouts are utilized.

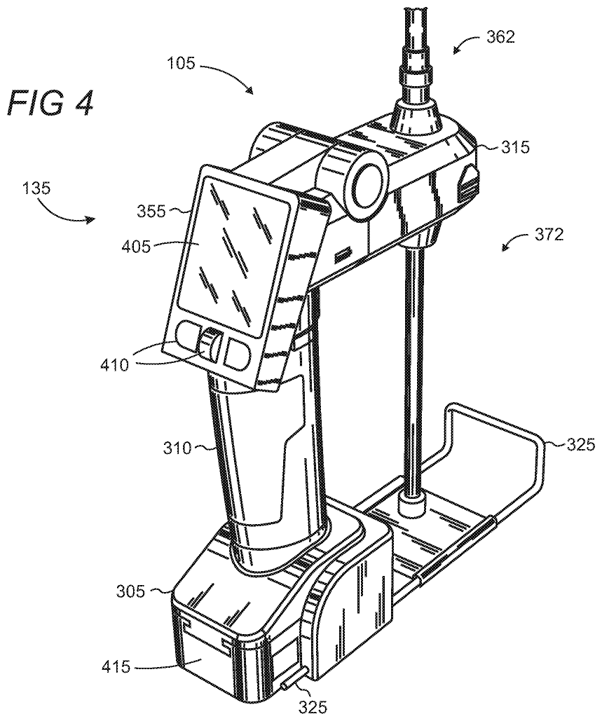

FIG. 4 shows an illustrative representation in which the computing module 355 includes I/O devices 135, which includes a display 405 and input mechanisms 410. The input mechanisms include buttons and a roll/click wheel 410 to enable a user to scroll and make selections. The input mechanisms may enable a user to switch the fluid transfer device 105 on and off and also enable the user to make operational selections for the pump, as discussed in greater detail below. In some implementations, the display 405 may be a touchscreen display which exposes information to a user and can receive user input, such as operational selections. FIG. 4 also shows the battery 140 which is located at the base 305. Various electronic circuitry and wiring 225 (not shown) may extend from the base's battery, through the handle, and to the computing module 355 and operational arm 315 to facilitate operations.

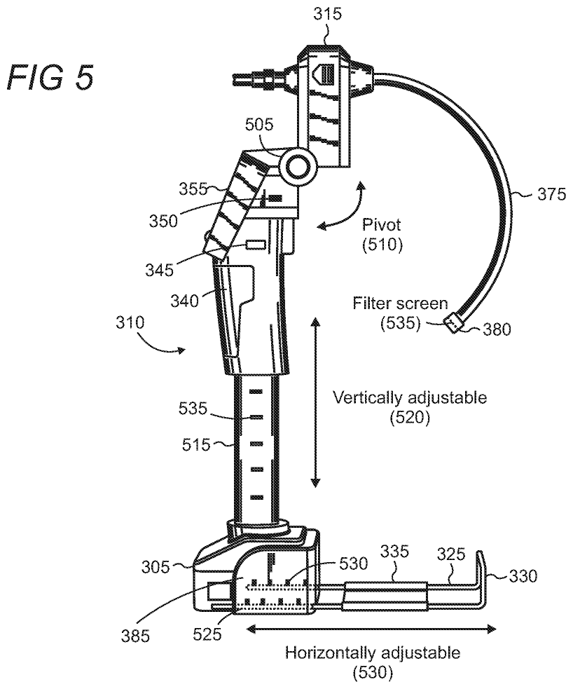

FIG. 5 shows an illustrative representation in which the fluid transfer device's adjustability, versatility, and adaptability is depicted. For example, a robust hinge 505 is implemented where the handle 310 and operational arm 315 meet. The hinge provides an upward pivot 510 to enable the operational arm to be lifted upward to make it easier for containers to be placed on the container rest 325. The hinge may lock in place when the operational arm is substantially at a 90° angle. In other implementations, the hinge locking mechanism may work at various acute and obtuse angles. The hinge lock switch 345 triggers a release to unlock the hinge and move the operational arm back to a horizontal position for use. For example, the hinge may include a protrusion that mates with a flange or recess to lock the arm in position. The release switch may either release the flange or the protrusion which thereby detaches the locking components.

The telescoping arm 515 underneath the handle includes spaced apart notches 515 to which tabs underneath the handle 310 engage with to lock the handle in multiple different positions. The tabs and notches may be friction fit to enable detachment responsive to sufficient user pressure. Alternatively, the lock switch 350 may provide a release mechanism that causes the tabs to be pushed inward and out of the notches. The telescoping functionality of the handle provides vertical adjustability of the handle to accommodate larger sized containers, as representatively illustrated by numeral 520.

The adapter 385 on the base 305 includes various notches which enable adjustability to the wire elements of the container rest 325. For example, tab protrusions on the wire elements can mate with corresponding recesses 530, or notches, inside the adapter to lock the container rest at multiple different positions. The broken lines represent the holes 525 inside the adapter through which the wire elements extend. The configuration of the holes 525 and use of the wire elements enable horizontal adjustability of the container rest to accommodate various sized containers, as representatively illustrated by numeral 530.

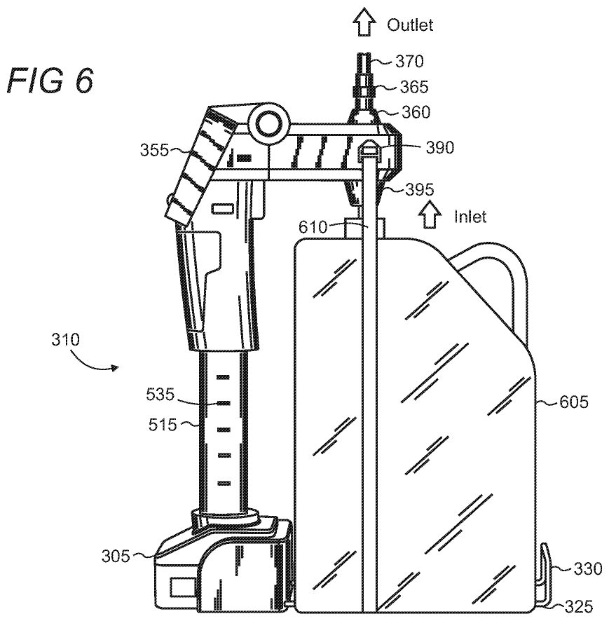

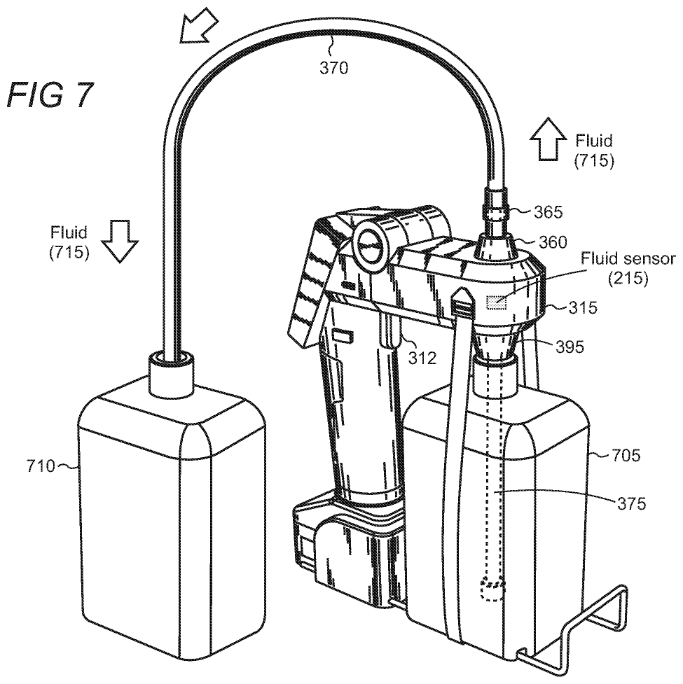

FIGS. 6 and 7 show illustrative representations in which subject containers 605, 705 are secured in place between the operational arm 305 and the container rest 325. The stopper 330 helps prevent the containers from horizontal movement. A nylon strap 610 is secured to the strap mount 390 and wraps around the bottom of the container rest 325 to secure and prevent the containers from lateral movement during fluid transfer operations. During operation, the fluid transfer device 105 pumps water into the inlet 372, through the internal tubes and/or hoses 230 of the fluid transfer device, and pushes the fluid to the outlet 362. FIG. 7 shows the flow path of the fluid to the outlet tube 370 and into a target container 710. While FIG. 7 shows the water coming into an inlet and out an outlet, in other implementations, the flow path may be reversed due to the bi-directional configuration of the fluid transfer device 105.

A fluid sensor 215 is also implemented inside the operational arm and within the flow path of the fluid to detect and report data about the fluid. For example, the sensor can be utilized to measure and gather data on an amount of fluid transferred, a rate at which fluid is being transferred, among other details. The sensor helps the automated fluid transfer operations to transfer a set amount of fluid and/or informs the user how much fluid has been transferred. For example, if the user pre-sets the computing module 355 to transfer one gallon of fluid, then the gathered data from the sensor triggers the computing module's processor 125 when the cease the fluid transfer operation.

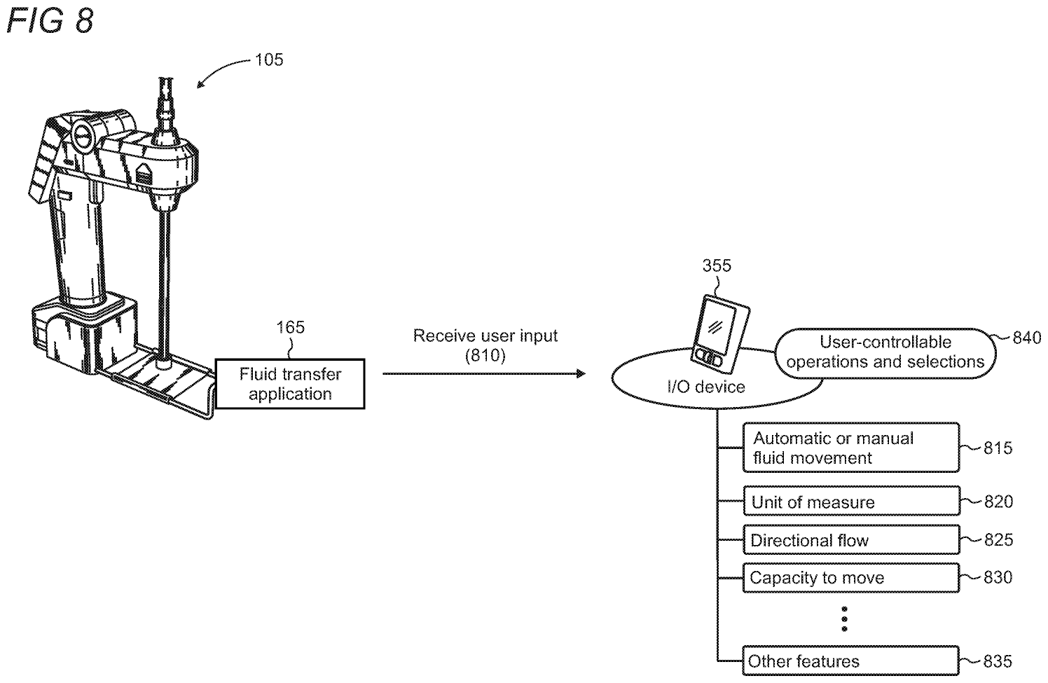

FIG. 8 shows an illustrative representation in which the fluid transfer device 105 is adapted to receive user input 810 to control the device's functionality. The fluid transfer application 165 instantiated on the fluid transfer device presents various selections to the user using the I/O devices 135 on the computing module 355. The I/O device provides user-controllable operations and selections 840 over the fluid transfer device using the fluid transfer application. For example, the fluid transfer application can receive user input in which the user selects automatic or manual fluid movement 815, unit of measure selection 820, directional flow 825, capacity to move 830 (e.g., amount of fluid to transfer and a rate at which the fluid is transferred), and other features 835.

The fluid transfer application 165 may be configured to certain default settings for the automated and manual operations. For example, the manual and automated operations may transfer fluid at a standard default rate or may be adjusted based on the user's selection. The manual operation operates responsive to and while the user holds down the actuator button 312, which actuates the motor 215 and thereby the pump 205 (FIG. 2). The automated operation operates responsive to the user pressing the actuator button and/or may operate without the user's constant pressure. The automated operation may stop fluid transfer when one or more parameters are met, such as a pre-set amount of fluid is transferred.

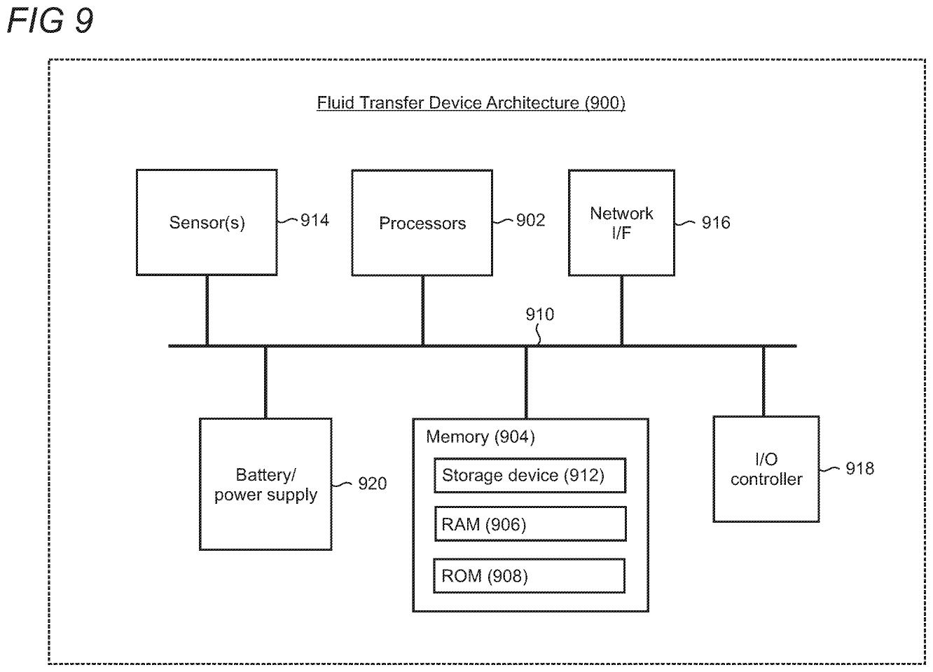

FIG. 9 shows an illustrative architecture 900 for a fluid transfer device 105 capable of executing the various features described herein. The architecture 900 illustrated in FIG. 9 includes one or more processors 902 (e.g., central processing unit, dedicated AI chip, discrete microcontroller, graphics processing unit, etc.), a system memory 904, including RAM (random access memory) 906, ROM (read only memory) 908, and long-term storage devices 912. The system bus 910 operatively and functionally couples the components in the architecture 900. A basic input/output system containing the basic routines that help to transfer information between elements within the architecture 900, such as during startup, is typically stored in the ROM 908. The architecture includes a sensor(s) 914 which may be operatively coupled to the processors 902. In the present implementation, the sensors may include a fluid sensor which can measure and gather data on the fluid in its flow path, such as an amount of fluid that has been transferred, a rate at which the fluid is moving, and other features.

The architecture 900 further includes a long-term storage device 912 for storing software code or other computer-executed code that is utilized to implement applications, the file system, and the operating system. The storage device 912 is connected to the processor 902 through a storage controller (not shown) connected to the bus 910. The storage device 912 and its associated computer-readable storage media provide non-volatile storage for the architecture 900. Although the description of computer-readable storage media contained herein refers to a long-term storage device, such as a hard disk or CD-ROM drive, it may be appreciated by those skilled in the art that computer-readable storage media can be any available storage media that can be accessed by the architecture 900, including solid stage drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 900.

According to various embodiments, the architecture 900 may operate in a networked environment using logical connections to remote computers through a network. The architecture 900 may connect to the network through a network interface unit 916 connected to the bus 910. It may be appreciated that the network interface unit 916 also may be utilized to connect to other types of networks and remote computer systems. The architecture 900 also may include an input/output controller 918 for receiving and processing input from a number of other devices, including a keyboard, mouse, touchpad, touchscreen, control devices such as buttons and switches or electronic stylus (not shown in FIG. 9). Similarly, the input/output controller 918 may provide output to a display screen, user interface, a printer, or other type of output device (also not shown in FIG. 9).

It may be appreciated that any software components described herein may, when loaded into the processor 902 and executed, transform the processor 902 and the overall architecture 900 from a general-purpose computing system into a special-purpose computing system customized to facilitate the functionality presented herein. The processor 902 may be constructed from any number of transistors or other discrete circuit elements, which may individually or collectively assume any number of states. More specifically, the processor 902 may operate as a finite-state machine, in response to executable instructions contained within the software modules disclosed herein. These computer-executable instructions may transform the processor 902 by specifying how the processor 902 transitions between states, thereby transforming the transistors or other discrete hardware elements constituting the processor 902.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 900 in order to store and execute the software components presented herein. It also may be appreciated that the architecture 900 may include other types of computing devices, including wearable devices, handheld computers, embedded computer systems, smartphones, PDAs, and other types of computing devices known to those skilled in the art. It is also contemplated that the architecture 900 may not include all of the components shown in FIG. 9, may include other components that are not explicitly shown in FIG. 9, or may utilize an architecture completely different from that shown in FIG. 9.

Disclosed herein are various embodiments that may be implemented for the fluid transfer device. For example, a fluid transfer device configured to transfer fluid from a subject container to a target container, comprising: a battery; a motor; a pump operatively coupled to the motor, in which the pump is utilized to suction fluid from outside of the fluid transfer device; a base adapted to be positioned on a surface; a handle that extends vertically from the base; and an operational arm that extends in a horizontal direction from the handle, wherein the operational arm includes: an inlet into which fluid is suctioned and received, in which the suctioned fluid enters the operational arm of the fluid transfer device; and an outlet which receives and directs the suctioned fluid out from the operational arm.

As another example, the outlet is upward facing and is positioned a top surface of the operational arm; and the inlet is downward facing and is positioned on an underside of the operational arm. In another example, the inlet includes a rubberized conical spout and an inlet hose which removably attaches to the conical spout. In another example, the outlet includes a rubberized conical spout, a quick-release collar, and an outlet hose which removably attaches to the quick-release collar. Another example further comprising at least one buckle mount positioned on lateral sides of the operational arm; and a strap which secures to the at least one buckle mount and extends downward to the surface on which the base is positioned to secure a container in place. Another example further comprises a container rest that extends horizontally from the base and which aligns at least in part with the operational arm such that the container rest is underneath the inlet, wherein the container rest includes a platform on which the container can at least partially rest. Another example further comprises further comprising an adapter which is attached to the base and from which the container rest extends, in which an extension of the container rest is adjustable by being pushed into and pulled out from the adapter. Another example further comprises a hinge positioned adjacent to the handle, wherein the hinge is adapted to enable upward pivotal movement of the operational arm about the hinge, in which the hinge locks the operational arm in place when the operational arm is in either a vertical or horizontal position. Another example further comprises a hinge button which unlocks the vertically positioned operational arm for re-positioning back to the horizontal position, wherein the hinge includes a tab which engages with a flange to lock the operational arm in place when vertically positioned. Another example further comprises an actuator button which initiates operation of the fluid transfer device. Another example further comprises: a display screen; an input mechanism; one or more processors; and a hardware-based memory device having executable instructions which, when executed by the one or more processors, cause the fluid transfer device to: receive user input using the input mechanism, in which the user input includes operational instructions for the fluid transfer device, including a directional flow of the fluid, a fluid transfer capacity, and a unit of measure. As another example, a control over the directional flow enables bi-directional movement of fluid between the inlet and outlet. In another example, the input mechanism includes a button to switch the fluid transfer device on and off, and further comprising an actuator button which initiates fluid movement operations of the fluid transfer device. Another example further comprises a fluid sensor positioned in a flow path of the fluid in the operational arm and which is operationally connected to the processor, the fluid sensor is configured to track data about the flow of the fluid to enable automated operations of the fluid transfer device, including the fluid transfer capacity.

In another exemplary embodiment, a fluid transfer device adapted to control a bi-directional transfer of fluid from a subject reservoir to a target reservoir is disclosed, comprising: an output device; an input device; one or more processors; a hardware-based memory device having executable instructions which, when executed by the one or more processors, cause the fluid transfer device to control bi-directional transfer of fluid using an inlet and an outlet; a base adapted for positioning on a surface, wherein the base includes a horizontally extending container rest; a handle extending vertical from the base, wherein the handle includes a grip to provide greater handling by a user and the handle is vertically adjustable to increase a height of the fluid transfer device, and wherein the handle includes the input and output devices for use; and an operational arm which extends horizontally from the handle, wherein the inlet is positioned on an underside of the operational arm and the outlet is positioned on a top surface of the operational arm.

As another example, the container rest is at least partially aligned with the operational arm and is positioned underneath the inlet. In another example, the executed instructions further cause the fluid transfer device to: responsive to receiving an initial user input, switch the fluid transfer device on; and responsive to receiving a subsequent user input, initiate suctioning of fluid at the inlet. In another example, the executed instructions enable the fluid transfer device to operate automatically according to input parameters or manually based on a user's control of an actuator. In another example, the input parameters include a fluid transfer capacity. Another example further comprises a hinge positioned between the handle and operational arm, wherein the operational arm pivots upward about the hinge to enable a user to place a container underneath the inlet between the surface and the operational arm.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A fluid transfer device configured to transfer fluid from a subject container to a target container, comprising:
a battery;
a motor;
a pump operatively coupled to the motor, in which the pump is utilized to suction fluid from outside of the fluid transfer device;
a base adapted to be positioned on a surface;
a handle that extends vertically from the base; and
an operational arm that extends in a horizontal direction from the handle, wherein the operational arm includes:
an inlet into which fluid is suctioned and received, in which the suctioned fluid enters the operational arm of the fluid transfer device; and
an outlet which receives and directs the suctioned fluid out from the operational arm.

2. The fluid transfer device of claim 1, wherein:
the outlet is upward facing and is positioned a top surface of the operational arm; and
the inlet is downward facing and is positioned on an underside of the operational arm.

3. The fluid transfer device of claim 1, wherein the inlet includes a rubberized conical spout and an inlet hose which removably attaches to the conical spout.

4. The fluid transfer device of claim 3, wherein the outlet includes a rubberized conical spout, a quick-release collar, and an outlet hose which removably attaches to the quick-release collar.

5. The fluid transfer device of claim 4, further comprising:
at least one buckle mount positioned on lateral sides of the operational arm; and
a strap which secures to the at least one buckle mount and extends downward to the surface on which the base is positioned to secure a container in place.

6. The fluid transfer device of claim 5, further comprising:
a container rest that extends horizontally from the base and which aligns at least in part with the operational arm such that the container rest is underneath the inlet, wherein the container rest includes a platform on which the container can at least partially rest.

7. The fluid transfer device of claim 6, further comprising an adapter which is attached to the base and from which the container rest extends, in which an extension of the container rest is adjustable by being pushed into and pulled out from the adapter.

8. The fluid transfer device of claim 4, further comprising a hinge positioned adjacent to the handle, wherein the hinge is adapted to enable upward pivotal movement of the operational arm about the hinge, in which the hinge locks the operational arm in place when the operational arm is in either a vertical or horizontal position.

9. The fluid transfer device of claim 8, further comprising a hinge button which unlocks the vertically positioned operational arm for re-positioning back to the horizontal position, wherein the hinge includes a tab which engages with a flange to lock the operational arm in place when vertically positioned.

10. The fluid transfer device of claim 1, further comprising an actuator button which initiates operation of the fluid transfer device.

11. The fluid transfer device of claim 1, further comprising:
a display screen;
an input mechanism;
one or more processors; and
a hardware-based memory device having executable instructions which, when executed by the one or more processors, cause the fluid transfer device to:
receive user input using the input mechanism, in which the user input includes operational instructions for the fluid transfer device, including a directional flow of the fluid, a fluid transfer capacity, and a unit of measure.

12. The fluid transfer device of claim 11, wherein control over the directional flow enables bi-directional movement of fluid between the inlet and outlet.

13. The fluid transfer device of claim 11, wherein the input mechanism includes a button to switch the fluid transfer device on and off, and further comprising an actuator button which initiates fluid movement operations of the fluid transfer device

14. The fluid transfer device of claim 11, further comprising a fluid sensor positioned in a flow path of the fluid in the operational arm and which is operationally connected to the processor, the fluid sensor is configured to track data about the flow of the fluid to enable automated operations of the fluid transfer device, including the fluid transfer capacity.

15. A fluid transfer device adapted to control a bi-directional transfer of fluid from a subject reservoir to a target reservoir, comprising:
an output device;
an input device;
one or more processors;
a hardware-based memory device having executable instructions which, when executed by the one or more processors, cause the fluid transfer device to control bi-directional transfer of fluid using an inlet and an outlet;
a base adapted for positioning on a surface, wherein the base includes a horizontally extending container rest;
a handle extending vertical from the base, wherein the handle includes a grip to provide greater handling by a user and the handle is vertically adjustable to increase a height of the fluid transfer device, and wherein the handle includes the input and output devices for use; and
an operational arm which extends horizontally from the handle, wherein the inlet is positioned on an underside of the operational arm and the outlet is positioned on a top surface of the operational arm.

16. The fluid transfer device of claim 15, wherein the container rest is at least partially aligned with the operational arm and is positioned underneath the inlet.

17. The fluid transfer device of claim 15, wherein the executed instructions further cause the fluid transfer device to:
responsive to receiving an initial user input, switch the fluid transfer device on; and
responsive to receiving a subsequent user input, initiate suctioning of fluid at the inlet.

18. The fluid transfer device of claim 15, wherein the executed instructions enable the fluid transfer device to operate automatically according to input parameters or manually based on a user's control of an actuator.

19. The fluid transfer device of claim 18, wherein the input parameters include a fluid transfer capacity.

20. The fluid transfer device of claim 15, further comprising a hinge positioned between the handle and operational arm, wherein the operational arm pivots upward about the hinge to enable a user to place a container underneath the inlet between the surface and the operational arm.
